(19) United States
(12) Patent Application Publication
(10) Pub. No.: US 2020/0156164 A1
(43) Pub. Date: May 21, 2020

(54) HOLE SAW INSERT ADAPTER FOR ACCURATELY RE-CUTTING HOLE DIAMETERS

(71) Applicant: Thomas John Caranese, (US)

(72) Inventor: Thomas John Caranese, Aurora, CO (US)

(21) Appl. No.: 16/194,306

(22) Filed: Nov. 17, 2018

(51) Int. Cl. B23B 51/04; B23B 51/00

(52) U.S. Cl. CPC B23B 51/0433; B23B 51/0018

(57) ABSTRACT

Mistakes are often made when using a hole saw to cut a hole for plumbing, electrical, carpentry, HVAC or other uses. Re-cutting a correct hole is difficult and time consuming. This invention enables a user to accurately re-drill a hole to a different diameter with the utilization of a simple insert adapter which saves time, increases productivity and reduces expense.

### FIELD OF INVENTION

A hole saw is a cylindrical saw blade attachment used in conjunction with a power drill or mill/drill press. It is rotated at various speeds and used to cut round holes in a variety of materials such as wood, metal, plastic and even brickwork. It is common for a user to mistakenly drill a hole with an incorrect diameter or to need to enlarge an existing hole (e.g. for a new lock set, plumbing piping, electrical conduit or door handle). As with many hole saws, there is a drill bit attached to an arbor to make a starter hole that will keep the saw blade aligned and secure. The starter hole is known as a “pilot hole”. There is currently no accessory which can be used as a guide to re-cut an incorrect diameter hole with accuracy. In fact, the current process is arduous and time consuming and involves clamping wood pieces over the existing hole, centering the pilot drill bit along with the proper hole saw blade and executing a new cut.

### SUMMARY OF THE INVENTION

A hole saw assembly is comprised of an arbor which receives a variety of cup-shaped hole saws. The arbor includes a pilot drill and a mandrel to be mounted within the chuck of a power tool (FIG. 1). The objective of the present invention is to provide an accessory that can be used to accurately re-drill a hole to a different diameter. The device being patented includes a tubular accessory of various diameters for use in an existing arbor which replaces the pilot drill bit.

It is possible for this accessory to be used for cutting through numerous materials, in which case it can be manufactured from various substances that are consistent with job requirements. The accessory will be available either as an individual item or as a set of different diameters.

This invention consists of a tubular accessory of various diameters that replaces the pilot drill bit and is secured to the arbor via a set screw so that the hole saw blade can be stabilized throughout the cutting process. Precision is provided as the accessory enters the original passage followed by a hole saw blade that is of the correct diameter. It is therefore possible during the cutting operation to attain a perfect circular hole centered around the existing hole.

The novel features which are considered as characteristic for the invention are set forth in particular in the appended claims. The invention itself will be best understood from the following description of specific embodiments when read in connection with the accompanying drawings.

### BRIEF DESCRIPTION OF THE DRAWINGS

FIG. 1 illustrates a conventional saw blade assembly which is currently used to create a hole in a workpiece without having to cut up the core material. It is used in a drill, drill mill or drill press. It typically consists of a pilot drill bit 1, a cutting head 2, a set screw 3, a shaft key 4 and a threaded arbor 5. The function of the drill bit on the end of the arbor is to create a pilot hole to decrease the chance of the cutting head ‘wandering’ when cutting. The shaft key is inserted into and clasped by the chuck of a power device.

FIG. 2 demonstrates the invention that is created as an accessory to the assembled arbor. It is manufactured with a permanent keyed shaft with a flat section for securing the accessory to the arbor 1. The inner wall is hollow for weight considerations 2. The outer wall is made of steel, aluminum and/or similar material 3.

FIG. 3 shows a prototype of an accessory that is less permanent than a steel or aluminum device as it is produced as a composite and/or polymer material. The keyed shaft has a flat section for securing the device to the arbor 1. The apparatus features a solid core 2 with a smooth outer wall 3.

FIG. 4 illustrates the invention being patented. It includes an existing arbor 1, the corrected hole saw blade 2, and the guide being patented 3.

FIG. 5 is an illustration of a completed assembly with the invention in position.

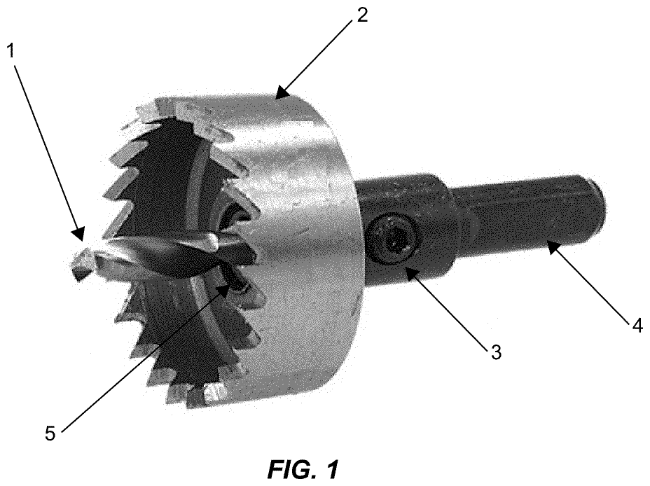

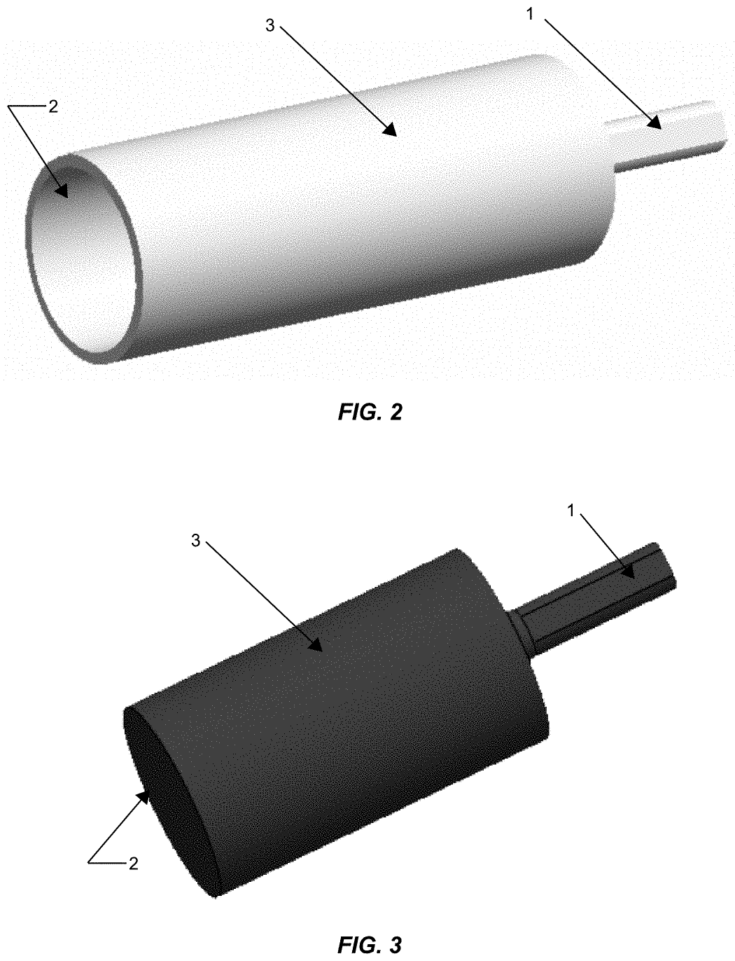

### DETAILED DESCRIPTION OF THE PREFERRED EMBODIMENT

A typical hole saw assembly or other hole cutter includes an arbor body with a threaded end portion that is used to tighten a saw blade to an end plate to secure a hole saw to the arbor. A pilot drill is located within the threaded end portion of the arbor body and extends through the center of the hole saw. Once a hole is cut, altering the size of the cut currently requires substantial efforts with questionable precision.

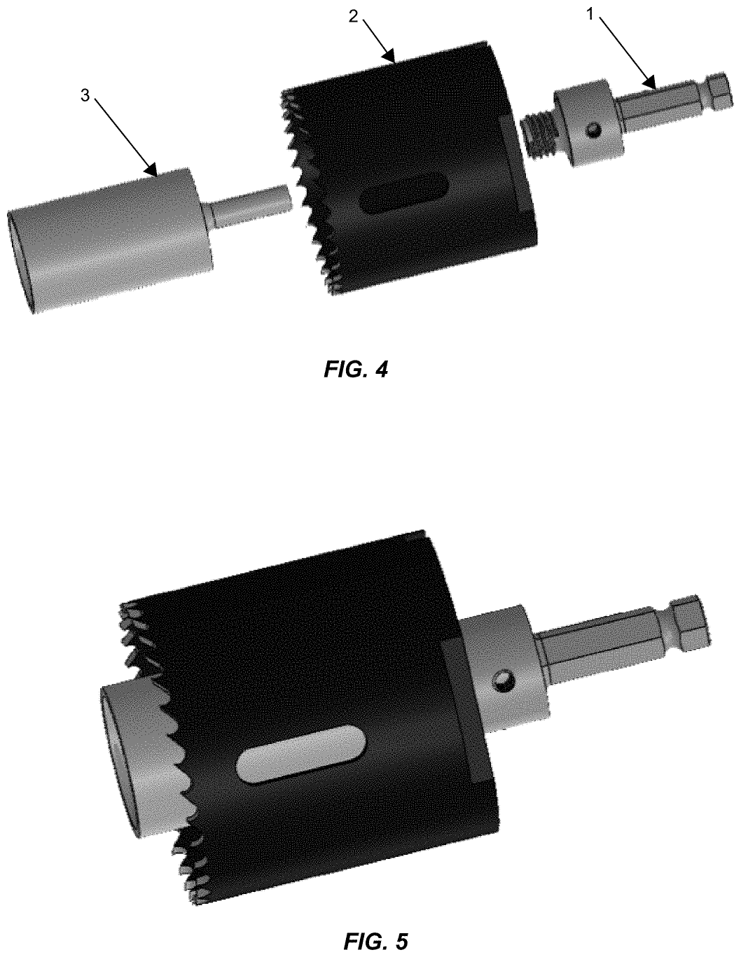

Referring now to FIG. 4 where the present invention can be observed that it consists primarily of a tube or solid rod dependent upon job requirements which is fastened to the arbor via a set screw that held the pilot drill bit. To attach the accessory, it is simply inserted into the drill bit chamber and held in place by tightening the set screw. This configuration generally conforms to all commercially available hole saw assemblies from all major manufacturers.

Hole saws are known to attach to various rotary tools. One such attachment is a circular cup-shaped saw blade attached to a power drill or the like. An arbor is used to affix the saw blade to a pilot bit, positioned in the center of the cup saw blade, and to enable the blade and pilot bit to be locked into the chuck of the cutting device. The pilot bit extends through a hole in the center of the cup saw blade.

In order to utilize the invention, the following steps need to be taken:
Remove the hole saw blade by unscrewing it from the arbor
Remove the pilot bit by loosening the set screw
Slide the invention into the pilot bit hole and tighten the set screw
Install the correct hole saw blade and tighten it to the arbor
The invention should now be protruding from the new saw blade
Insert the invention into the existing hole as a stable guide

The invention will now keep the new saw blade in perfect alignment

Development

Materials used in the production of the hole saw will vary depending upon requirements of strength and cost of production.

Validation:

The hole saw adapter invention was tested to ensure accuracy and the control of wobbling/walking in re-cutting holes in various materials including plastic, wood and metal. In performing these tests both the polymer product and a milled steel product were deployed to enlarge a previous out with exact precision regardless of the diameter or speed of the cutting device. There are a wide variety of hole saws available in the marketplace, from inexpensive carbon steel to extremely specialized, application driven hole saws. The moat commonly used saw, however, is the bi-metal hole saw. Regardless of the composition of the hole saw being utilized, the invention will perform to standard. Durability of the invention will ultimately be dependent upon the number of uses and different user cutting techniques.

### Glossary of Claim Terms

As used throughout the entire application, the terms “a” and “an” are used in the sense that they mean “at least one”, “at least a first”, “one or more” or “a plurality” of the referenced components or steps, unless the context clearly dictates otherwise.

The term “and/or” wherever used herein includes the meaning of “and”, “or” and “all or any other combination of the elements connected by said term”.

The term “about” or “approximately” as used herein means within 20%, preferably within 10%, and more preferably within 5% of a given value or range.

As used herein, the term “comprising” is intended to mean that the products, compositions and methods include the referenced components or steps, but not excluding others. “Consisting essentially of” when used to define products, compositions and methods, shall mean excluding other components or steps of any essential significance.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated to show details of particular components. Therefore, specific structural and functional details disclosed herein are not to be interpreted as limiting, but merely as a basis for the claims and as a representative basis for utilizing the present invention.

Certain terminology will be used in the preceding description for convenience and reference only and not for purposes of limitation. For example, the words “horizontally” and “vertically” can refer to directions in the drawings to which reference is made. The words “inwardly” and “outwardly” refer to directions toward and away from, respectively, the geometric center of the structure being referred to. This terminology includes these words, specifically mentioned derivatives thereof, and words of similar import.

All references cited in the present application are incorporated in their entirety herein by reference to the extent not inconsistent herewith.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now that the invention has been described,

What is claimed is:

1. Utilization of the invention enables holes to be accurately cut to repair an inadvertent error or to enlarge a previously drilled hole to different specifications.

2. The invention fits most commercially available hole saw assemblies which utilize a removable pilot drill bit.

3. There is no similar device in the marketplace.

4. Holes of any size can be accommodated by the invention.

5. Composition of the invention can either be ‘disposable’ (e.g. a solid polymer material) or permanent (e.g. aluminum, titanium, steel, etc.).

6. Standard sizes of the invention can be produced at very low cost and can be sold either as an individual accessory or as a ‘set’ which complements the array of hole saw sets in the marketplace.

7. Cost of manufacturing the invention is mitigated by the simple design, with polymer cast as a solid plug and other materials cast with a tubular core to minimize weight.

8. Utilizing the device will allow precision hole cutting with no arduous set up requirements. Productivity and precision will therefore be significantly enhanced.
